(19) United States
(12) Patent Application Publication
(10) Pub. No.: US 2014/0248526 A1
(43) Pub. Date: Sep. 4, 2014

(54) GALVANIC ELEMENT WITH ENHANCED SAFETY PROPERTIES

(71) Applicants: Samsung SDI Co., Ltd., Yongin-si (KR); Robert Bosch GmbH, Stuttgart (DE)

(72) Inventors: Thomas Wöhrle, Munchen (DE); Markus Kohlberger, Stuttgart (DE)

(73) Assignees: Samsung SDI Co., Ltd., Yongin-si (KR); Robert Bosch GmbH, Stuttgart (DE)

(21) Appl. No.: 14/184,992

(22) Filed: Feb. 20, 2014

(30) Foreign Application Priority Data
Mar. 1, 2013 (DE) 10 2013 203 485.7

(51) Int. Cl. H01M 2/16; H01M 10/0525; H01M 2/14

(52) U.S. Cl. CPC H01M 2/1686; H01M 2/145; H01M 2/1653; H01M 2/1646; H01M 10/0525
USPC 429/145; 156/306.3

(57) ABSTRACT

A separator is configured to be used with a galvanic element which includes at least one positive electrode, to be separated from the separator, and at least one negative electrode. The separator includes a first microporous membrane, made of a nonpolyolefin-based polymer, and at least one second microporous membrane made of a polyolefin polymer. A melting or softening temperature of the first microporous membrane is higher than a melting or softening temperature of the at least one second membrane.

This application claims priority under 35 U.S.C. §119 to patent application number DE 10 2013 203 485.7, filed on Mar. 1, 2013 in Germany, the disclosure of which is incorporated herein by reference in its entirety.

### BACKGROUND

Lithium ion cells, which are also referred to as lithium ion polymer cells or lithium polymer cells, or, respectively, as corresponding modules, packs or batteries, accumulators or systems, are galvanic elements which have at least one positive electrode and at least one negative electrode featuring an intercalation structure, into which lithium ions can be reversibly intercalated or deintercalated, i.e., inserted and removed, respectively. A further requirement is the presence of a lithium ion conductive salt, which at present, in both the consumer and the automobile segments, is preferably lithium hexafluorophosphate (LiPF₆). In all operational states, the lithium ions pass through a porous separator that separates the positive and negative electrodes from one another.

Lithium ion cells are notable for a very high specific energy density, a low self-discharge rate, and virtually no memory effect. However, lithium ion batteries consistently contain a flammable electrolyte and often other flammable cell materials, such as carbon black or aluminum foil. In the event of overcharging or damage to lithium ion batteries, there may be instances of fire or explosion. It is therefore necessary to equip lithium ion batteries with safety mechanisms, in order to interrupt the circulation of current in the battery as and when necessary. For enhanced intrinsic safety, a critical significance is accorded to the porous separators in these systems.

There are separators known that are made of porous, polyolefin-based plastics, for example polyethylene, polypropylene or a polypropylene-polyethylene composite. Above a defined temperature, also referred to as the shutdown temperature, there is rapid melting, particularly in the case of polyethylene (PE), and so the pores in the separator become blocked and are therefore sealed off. The current circuit is irreversibly interrupted and there is no further uncontrolled discharge. This mechanism is called a shutdown mechanism. Polyolefin separators, specifically, possess the adverse property under thermal stress of undergoing all-round contraction, and in this case there is an extensive internal short circuit. The component having a higher melting temperature continues to ensure mechanical stability, although the stability can be maintained only to a limited extent.

In the case of the polyolefin-based polymer sheets employed with separators, in particular, there may be all-round contraction of the sides (shrinking) and hence a direct contact between the electrodes of the galvanic element, with shortcircuiting occurring.

DE 10 2009 035 759 A1 discloses a separator of a galvanic element that consists at least partly of a polymer whose melting and/or softening temperature is above 200° C. and that is distinguished by a low level of shrinking. High-temperature-resistant thermoplastic polymers are specified, as for example polyetherketones (PEK) and polyetheretherketones (PEEK). The increased thermal stability achieved as a result, however, means that a reliable, heat-sensitive protection mechanism integrated into the cell is not ensured at any time. The greater the thermal stability of a porous polymeric membrane, the slower the blocking of the pores. Slowed down accordingly is the blockade of lithium ion transport, and hence the interruption to the overall current circuit.

### SUMMARY

Proposed in accordance with the disclosure is a separator for a galvanic element, more particularly for a lithium ion cell, which comprises a negative electrode (cathode) and a positive electrode (anode), and also a method for producing a separator, and a galvanic element, with a separator separating the electrodes. In accordance with the disclosure, the separator comprises a first microporous membrane made of a nonpolyolefin-based polymer, and at least one second microporous membrane made of polyolefin polymer, the first membrane having a higher melting or softening temperature than the at least second membrane.

Membranes here are thin, porous systems with high permeability for certain substances, in conjunction with good mechanical strength and long-term stability toward the substances present during their service. The membranes form a membrane assembly, which overall possesses a porosity which is sufficient to be filled up with the electrolyte used in a galvanic element. The membrane assembly, also referred to as separator composite or separator assembly, may easily be produced from commercially customary porous monofilm membranes, which may be present in the form, for example, of a nonwoven web, knitted fabric or woven fabric.

Polyolefin polymers in the sense of the disclosure are those polymers which are formed by polymerization of olefins, the monomers consisting exclusively of carbon and hydrogen, and belonging more particularly to the homologous group of the alkenes. Nonpolyolefin-based polymers, in contrast, are understood to be all kinds of polymers with the exception of the polyolefin polymers in the sense of the disclosure as defined above.

The separator of the disclosure with the features described below provides an at least two-ply assembly composed of a first layer, also referred to as core membrane, made of a polymer which is not polyolefin-based, having a high melting temperature, and of a second layer, also referred to as auxiliary membrane, made of a polyolefin polymer having a lower melting temperature than that of the core membrane, ensuring simultaneously a shutdown mechanism and reliable separation of the electrodes still in the event of high temperatures occurring.

The melting temperature of a substance is the temperature at which it melts, i.e., passes from the solid into the liquid aggregate state. For polymers, this temperature cannot always be specified to one value, and so, instead, the abovementioned softening temperature can also be used as a characteristic value. The softening temperature, also referred to as glass transition temperature, is the temperature at which a polymer exhibits the greatest change in capacity for deformation. Polymers in some cases do not exhibit an exact melting point, but instead melt within a temperature range, in which case the lower limit of the range is to be considered the melting or softening temperature.

Polymers contemplated for the core membrane in one embodiment of the separator of the disclosure include polymers which have a melting and/or softening temperature in the range from 165 to 320° C. Essentially these are polymers selected from the group of polyesters, e.g., polyethylene terephthalate (PET), polyimide (PI), polytetrafluoroethylene (PTFE), polyvinylidene fluoride (PVdF), polyvinylidene fluoride-hexafluoropropylene copolymer (PVdF-HFP), polyurethane (PU), polyamide (PA) or aramid.

The temperature stability of the membrane assembly, and also, largely, the mechanical stability, are critically determined by the polymer of the core membrane. This core membrane may be used in the form of a thin and also mechanically stable substrate made of fibers of the high-temperature-resistant polymers, polymers joined in woven, braided or other form. A diversity of such membranes are available commercially, and differ in features including the polymers, in terms of the material itself, construction, possibly fillers, porosity and/or thickness.

In accordance with the disclosure, the separator comprises a further layer of a polyolefin-based plastic having a low melting and/or softening temperature which lies in a range from 100 to 165° C. Suitable more particularly are polyethylene, polypropylene, and polyethylene-polypropylene copolymers, and the layer, which is also termed an auxiliary membrane, may also in turn be of multilayer construction. The use of such polymer membranes, which are likewise available commercially, exhibits chemical resistance with respect to strong bases.

As far as the geometry of the separator assembly is concerned, it has an assembly thickness which may lie in the range between 5 μm and 50 μm, preferably between 10 μm and 40 μm, and more preferably between 15 μm and 25 μm.

Another embodiment of the separator of the disclosure sees the membrane assembly coated with ceramic particles. A ceramic-based coating of this kind, applied to at least one side of the separator, stabilizes the latter further with respect to thermal and mechanical loads. The coating of the separator of the disclosure may feature an electrically nonconducting oxide of the metals Al, Zr, Si, Sn, Ti and/or Y. A ceramic which is itself a lithium ion-conducting ceramic may also be used, and in particular the current capability of the galvanic element is increased with a separator of this kind. Also contemplated, in addition to the aforementioned oxides, are phosphates, sulfides, and titanates.

For improved adhesion of the coating it is possible with preference to use an adhesion promoter having a solidification temperature which lies below the softening and/or melting temperature of the membranes used. The separator of the disclosure may be coated on both sides, in each case facing the electrodes. The thickness of the porous ceramic coating is in the range between 1 μm and 20 μm, preferably between 2 μm and 6 μm.

The porous composite coating may comprise a binder, as for example polyvinylidene fluoride (PVdF), polyvinylidene fluoride-hexafluoropropylene copolymer (PVdF-HFP) or polyethylene oxide (PEO), and ceramic particles having generally spherical shape. The size distribution of the ceramic particles is selected to enable a porosity of the separators known from the prior art to be established. A corresponding porosity in the ceramic coating is between 33% and 66%. To set a porosity of 50% in a composite, for example, a dry layer of 5 μm thickness is used with ceramic particles in the submicron range, e.g., with a size of around 700 nm.

In accordance with the disclosure, the separator comprises at least two membranes, which form an assembly. An assembly of this kind may be constructed, for example, by the calendering of two porous polymeric-film membranes, which are available under a variety of trade names. The calendering operation may optionally be assisted by heat, in which case suitable temperatures are about 20° C. below the glass transition temperature of the low-melting polymer.

In one preferred embodiment of the separator of the disclosure, the membrane assembly comprises, between the individual membranes, a layer of adhesion promoter, which provides the join between the core membrane and the at least one auxiliary membrane. The adhesion promoter layer preferably has electrically insulating properties, but is pervious for common electrolytes. It may be preferable for the individual membranes to be bonded adhesively to one another over their full area or locally. In the latter case, the adhesion promoter is arranged in the form of one or more dots between the individual membrane plies.

The adhesion promoter is preferably applied in liquid form, by means, for example, of spraying, printing, pressing, injecting, rolling, knifecoating, brushing, dipping, squirting, or pouring. An adhesion promoter of this kind is an adhesive which can be employed at room temperature and which is not heat-activatable and/or room-temperature-curable. More particularly, the adhesion promoter used is chemically inert with respect to the constituents used in a galvanic element. The adhesion promoter, furthermore, comprises chemically curing adhesives, and either a one-component system or else a multicomponent system is possible. Physically settable adhesives may also be employed. For example, the adhesion promoter may be polyurethane- or epoxy resin-based, but may also be a one-component or multicomponent system. An alternative option is to use acrylate or polysiloxane laminating adhesives.

The separators of the disclosure are used preferably in galvanic elements featuring at least one lithium-intercalating electrode and one lithium-deintercalating electrode. The present application additionally provides a galvanic element, more particularly in a lithium ion cell, with the separator of the disclosure. The galvanic element has at least one positive electrode and one negative electrode, with the sequence present being negative electrode/separator/positive electrode.

In another embodiment of the galvanic element, the separator is joined to the electrodes via adhesion promoters, thereby allowing, advantageously, a particularly gentle processing of the individual elements. An adhesive bonding operation of this kind can be integrated easily into a production operation, with no need for expensive and complex measures. The adhesion promoter here may be applied to one or both surfaces to be joined, and may be subjected, where appropriate, to preliminary drying and, optionally, to activation. The adhesive bonding operation may likewise be assisted by application of pressure, with a pressure that can be adjusted individually, with the assembly of electrodes and separator being immediately mechanically robust.

By adapting the starting materials of the separator of the disclosure, or else by means of further aftertreatments of said separator, account may be taken of the various chemical and technical requirements.

A feature of the solution proposed in accordance with the disclosure is that the separator proposed in accordance with the disclosure and the galvanic element proposed in accordance with the disclosure have a substantially higher safety level, as compared with conventional galvanic elements. If the membrane assembly is used as the separator in a secondary cell, the greater thermal load-bearing capacity means that this secondary cell possesses greater intrinsic safety under thermal stress in a substantially higher temperature range, from 50° C. to 300° C.

One of the features of the separator proposed in accordance with the disclosure is a high-temperature-resistant, microporous membrane, which is distinguished by a considerable increase in the tensile strength and puncture resistance. Furthermore, the separator of the disclosure thus possesses good mechanical stability, including stability with respect to mechanical loads such as vibrations.

In the temperature range in which peripheral contraction occurs with conventional, polyolefin-based separators, the high-temperature-resistant polymers exhibit little or no contraction. Accordingly, the separator proposed in accordance with the disclosure is thermally and mechanically stable and exhibits no change in geometry, of whatever kind.

The separator of the disclosure combines a shutdown mechanism with minimal contraction and an increased temperature difference between the onset of auxiliary membrane melting and a loss of core membrane stability as melting sets in. Accordingly, it is possible to increase the temperature difference, and hence also the time period, before “melt down” is experienced, i.e., the melting of the entire separator.

The separator proposed in accordance with the disclosure may be produced in an extremely cost-effective way from commercially customary microporous membranes, producing a membrane assembly or the assembled membrane which provides a high degree of intrinsic safety.

Furthermore, with, for example, a core membrane of polyimide, oriented toward the cathode, the separator of the disclosure has a relatively high electrochemical quality. The stabilized composite membrane proposed in accordance with the disclosure is more stable in the case of electrical overcharging as a stress factor.

### BRIEF DESCRIPTION OF THE DRAWINGS

Further advantages and embodiments of the subject matter of the disclosure are illustrated by the drawings and elucidated in more detail in the description hereinafter.

In the drawings:

FIG. 1 shows the migrational direction of lithium⁺ ions during charging, from the positive electrode to the negative electrode;

FIG. 2 shows the migration of the lithium⁺ ions during discharging, from the negative to the positive electrode; and

FIG. 3 shows a schematic cross section through one embodiment of a separator of the disclosure.

### DETAILED DESCRIPTION

Apparent from the depiction according to FIG. 1 is the migrational direction of the Li⁺ ions during the charging 22 of a galvanic element.

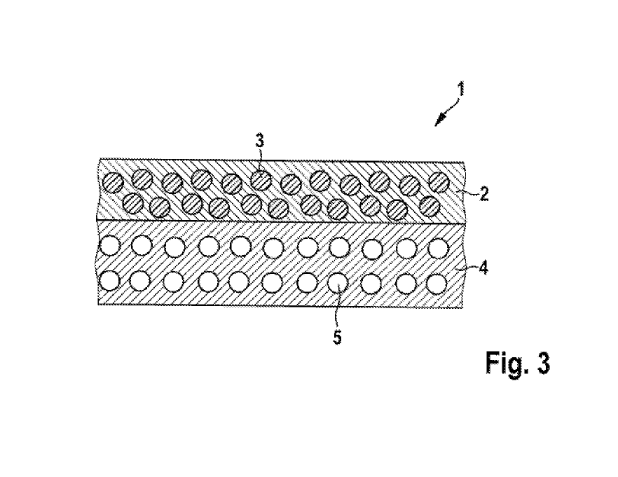

A galvanic element 10, whose components are indicated only schematically in FIG. 1, comprises a positive electrode 12 (anode) and a negative electrode 14 (cathode). A current flowing between the two electrodes 12 and 14 can be measured by means of an ammeter 16. Located in the space 18 between positive and negative electrodes 12 and 14 is a lithium ion-conducting electrolyte. Generally speaking, the electrolyte is a liquid electrolyte, as for example a 1-molar solution of lithium hexafluorophosphate, LiPF₆, in a mixture of organic solvents. The organic solvents may be, for example, ethylene carbonate (EC), propylene carbonate (PC), ethyl methyl carbonate (EMC), diethyl carbonate (DEC), or symmetrical or asymmetrical ethers. This liquid electrolyte ensures the wetting of a separator depicted in connection with FIG. 3.

Indicated in FIG. 1 is a migrational direction of the Li⁺ ions during charging 22, by means of reference symbol 20.

Charging 22 is evident from the following reaction equation:

C₆+LiMO₂→LiC₆+Li₍₁₋ₓ₎MO₂

M=transition metal oxide, as for example cobalt (Co), manganese (Mn) or nickel (Ni).

Furthermore, reference symbol 28 indicates the positive side of the galvanic element 10, and reference symbol 30 the negative side.

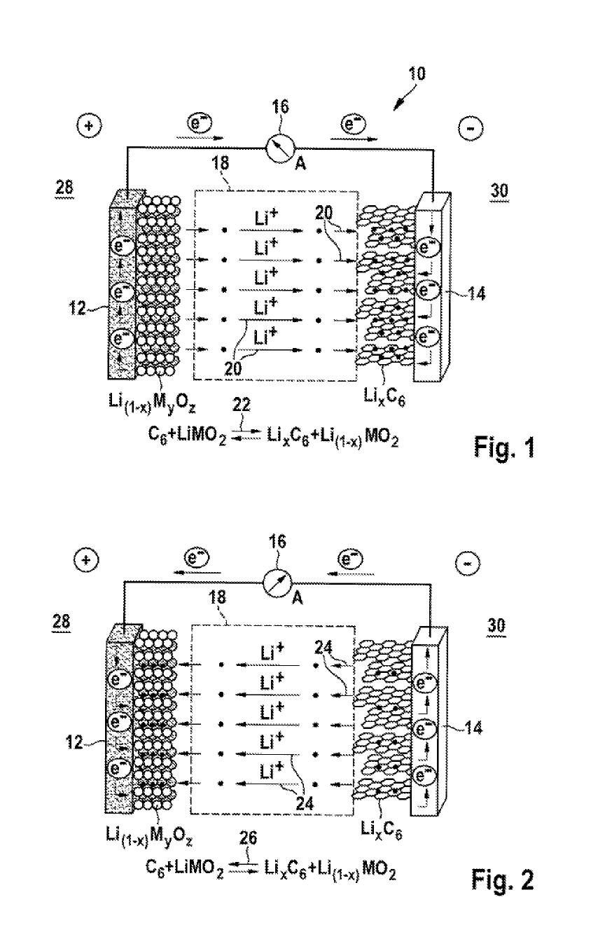

The depiction according to FIG. 2 shows discharging 26 of the galvanic element 10, with the Li⁺ ions migrating, in opposition to the migrational direction 20 depicted in FIG. 1, from the negative electrode 14 to the positive electrode 12, this migration being identified by reference symbol 24.

The construction of the galvanic element 10 according to the depiction in FIG. 2 is analogous to the construction of the galvanic element according to the depiction in FIG. 1, with FIG. 2 showing discharging 26. Discharging 26 is likewise based on the reaction equation above, which, however, proceeds in the opposite direction.

The depiction according to FIGS. 1 and 2 serves for depicting the reversible insertion and removal, i.e., the intercalation and deintercalation, of the Li⁺ ions.

FIG. 3 shows a cross section through a separator 1 of the disclosure, with a first layer, also identified as core membrane 2. The core membrane 2 comprises a nonpolyolefin-based polymer, this polymer instead being a high-temperature-resistant polymer, such as polyester. In the exemplary embodiment shown in FIG. 3, the core membrane 2 has a thickness of 5 to 50 μm, and is used in the form of a nonwoven web or woven or knitted fabric. The core membrane 2 is constructed of fibers selected from the group of polymers comprising polyimide, polyesters, aramid, polyvinylidene fluoride (PVdF), polyvinylidene fluoride-hexafluoropropylene copolymer (PVdF-HFP), polytetrafluoroethylene (PTFE) or polyether ketones (PEK). In the exemplary embodiment shown, the core membrane 2 has a labyrinth porosity, indicated by reference symbol 3. This labyrinth porosity is a porosity which does not have a regular pattern and in particular does not have any open channels or regions through which the two sides of the separator enter directly into communication. Individual labyrinth channels of the labyrinth porosity represent culs-de-sac.

The thickness of the core membrane 2 and also of the separator 1 as a whole has a great influence on the properties in the case of use in a galvanic element 10, since the flexibility and also the sheet resistance of the electrolyte-impregnated separator 1 are dependent thereon Thinner separators permit an increased packing density in a battery stack, and hence storage of a greater quantity of energy within a given volume.

The separator 1 of the disclosure in FIG. 3, furthermore, has a second layer, also referred to as auxiliary membrane 4. In the exemplary embodiment shown, the auxiliary membrane 4 is a porous, polyolefin-based polymeric film in a thickness which differs from that of the core membrane 2. Polyolefin polymers found to be suitable are polyethylene, polypropylene and/or polyethylene-polypropylene copolymers.

In the separator 1 shown in FIG. 3, the core membrane 2 and the auxiliary membrane 4 differ in their porosity. In particular, the auxiliary membrane 4 may be present with an open porosity, indicated by reference symbol 5. The core membrane 2 exhibits a labyrinth porosity 3, as a result of which fewer lithium dendrites are formed.

The present disclosure is described in more detail by the examples which follow.

### Example 1

Li Ion Cell with a Prior-Art Reference Separator

A reference separator comprises a porous polyolefin membrane with a thickness of approximately 35 μm. The Li ion cell constructed according to Example 1 comprises a positive composition, consisting of a 50:50 mixture of lithium cobalt oxide (LiCoO₂) and lithium nickel cobalt manganese oxide (LiNi_{0.33}Co_{0.33}Mn_{0.33}), and a negative composition, consisting of synthetic graphite (MCMB6-28).

Ten specimen cells were constructed, and the nominal capacity achieved was 5.8 Ah. The 100% SOC (state of charge) of the cell is at 4.20 V.

### Example 2

Li Ion Cell with a Disclosed Separator in Accordance with an Exemplary Embodiment

A disclosed separator comprises a porous, polymeric film of polyester with a thickness of approximately 22 μm, as core membrane, and a porous, polymeric film of polyethylene with a thickness of approximately 18 μm, as auxiliary membrane, these membranes having been calendered to form a membrane assembly with a thickness of approximately 39 μm. The Li ion cell constructed according to Example 2 comprises a positive composition, consisting of a 50:50 mixture of lithium cobalt oxide (LiCoO₂) and lithium nickel cobalt manganese oxide (LiNi_{0.33}Co_{0.33}Mn_{0.33}), and a negative composition, consisting of synthetic graphite (MCMB6-28).

Ten specimen cells were constructed, and the nominal capacity achieved was 5.8 Ah. The 100% SOC (state of charge) of the cell is at 4.20 V.

### Example 3

Li Ion Cell with a Disclosed Separator in Accordance with an Exemplary Embodiment

A disclosed separator comprises a porous, polymeric film of polyimide with a thickness of approximately 20 μm, as core membrane, and a porous, polymeric film of polyethylene with a thickness of approximately 14 μm, as auxiliary membrane, these membranes having been calendered to form a membrane assembly with a thickness of approximately 33 μm. The Li ion cell constructed according to Example 3 comprises a positive composition, consisting of a 50:50 mixture of lithium cobalt oxide (LiCoO₂) and lithium nickel cobalt manganese oxide (LiNi_{0.33}CO_{0.33}Mn_{0.33}), and a negative composition, consisting of synthetic graphite (MCMB6-28).

Ten specimen cells were constructed, and the nominal capacity achieved was 5.8 Ah. The 100% SOC (state of charge) of the cell is at 4.20 V.

Table 1 shows the results of a penetration test. A customary nail penetration safety test represents a standard within battery technology, and is described in SANDIA REPORT (SAND2005-3123), August 2006, in accordance with EUCAR/USABC Abuse Test Procedures.

The valid test parameters here are as follows:

Penetration of the cell or of the module with a nail at a velocity of 8 cm/sec. For individual cells, the nail diameter is 3 mm The test is passed if, in accordance with the EUCAR Hazard Levels, there is leakage, but less than 50% of the electrolyte is emitted and, moreover, there is no fire, no flame, no destructive tearing, and no explosion in the cell.

The nail penetration safety test was carried out on batches of 10 lithium ion cells as per Examples 2 and 3 and, as a reference, as per Example 1. The cells are fully charged in each case (100% SOC, 4.20 V).

TABLE 1

| | | Number of | Number of | |
|---|---|---|---|---|
| | | EUCARLEVEL | EUCARLEVEL | Number of |
| Lithium | | 3 cells | 4 cells | EUCARLEVEL |
| ion cell | SOC | (electrolyte mass | (electrolyte mass | 5 cells (fire or |
| variant | in % | loss <50%) | loss >50%) | flaming) |
| 1.) | 100 | zero | seven | three |
| 2.) | 100 | ten | zero | zero |
| 3.) | 100 | ten | zero | zero |

As can be seen from Table 1, all disclosed cells pass the test according to the specifications already described, whereas for the reference cells either more than 50% of the cell contents are emitted, or, in fact, development of fire and/or flaming is observed.

What is claimed is:

1. A separator for a galvanic element which has at least one positive electrode, to be separated from the separator, and at least one negative electrode, the separator comprising:
a first microporous membrane made of a nonpolyolefin-based polymer; and
at least one second microporous membrane including a polyolefin polymer,
wherein a melting or softening temperature of the first microporous membrane is higher than a melting or softening temperature of the at least one second microporous membrane.

2. The separator according to claim 1, wherein a material of the first microporous membrane is selected from polyester, polyimide, polytetrafluoroethylene, polyvinylidene fluoride, polyvinylidene fluoride-hexafluoropropylene copolymer, polyurethane, polyamide and aramid.

3. The separator according to claim 1, wherein a material of the at least one second porous membrane is selected from polyolefin polymers including at least one of polyethylene, polypropylene, and polyethylene-polypropylene copolymers.

4. The separator according to claim 1, further comprising a coating with electrically nonconducting oxides of at least one of metals aluminum, zirconium, silicon, tin, titanium, germanium and yttrium.

5. The separator according to claim 1, wherein the at least one second microporous membrane is applied to the first microporous membrane by at least one adhesion promoter.

6. A method for producing a separator for a galvanic element, the method comprising:
applying at least one second microporous membrane including a polyolefin polymer to a first microporous membrane made of a nonpolyolefin-based polymer, a melting or softening temperature of the at least one second microporous membrane being below a melting or softening temperature of the first microporous membrane;
joining the first microporous membrane and the at least one second microporous membrane by calendering; and
joining the first microporous membrane and the at least one second microporous membrane by exposure to heat to form a membrane assembly.

7. The method according to claim 6, wherein the joining the first microporous membrane and the at least one second microporous membrane includes joining the first microporous membrane and the at least one second microporous membrane by at least one adhesion promoter.

8. A galvanic element, comprising:
at least one lithium-intercalating electrode;
at least one lithium-deintercalating electrode; and
at least one separator, including:
a first microporous membrane made of a nonpolyolefin-based polymer; and
at least one second microporous membrane including a polyolefin polymer,
wherein the first microporous membrane has a melting or softening temperature that is higher than a melting or softening temperature at least one second microporous membrane.

9. The galvanic element according to claim 8, wherein the at least one separator is joined to the positive electrode and to the negative electrode by an adhesion promoter.

10. The separator according to claim 1, wherein the galvanic element is a lithium ion cell.
